(19) United States
(12) Patent Application Publication
(10) Pub. No.: US 2025/0083954 A1
(43) Pub. Date: Mar. 13, 2025

(54) METHANE PYROLYSIS FOR PRODUCTION OF HYDROGEN

(71) Applicant: SAUDI ARABIAN OIL COMPANY, Dhahran (SA)

(72) Inventors: Sehmus OZDEN, Katy, TX (US); Feng LIANG, Houston, TX (US); Hung Q. TRUONG, Cypress, TX (US)

(73) Assignee: SAUDI ARABIAN OIL COMPANY, Dhahran (SA)

(21) Appl. No.: 18/465,362

(22) Filed: Sep. 12, 2023

(51) Int. Cl. C01B 3/26; B01D 53/22; B01J 21/04; B01J 23/745; B01J 23/78; C01B 3/30; C01B 3/50; C01B 32/05

(52) U.S. Cl. CPC C01B 3/26; B01D 53/22; B01J 21/04; B01J 23/745; B01J 23/78; C01B 3/30; C01B 3/501; C01B 32/05; B01D 2256/16; B01D 2257/7025; C01B 2203/0277; C01B 2203/041; C01B 2203/0805; C01B 2203/1058; C01B 2203/1082; C01B 2203/1241

(57) ABSTRACT

Hydrogen may be produced from a hydrocarbon through catalytic means. An example method of catalytic hydrogen production includes: introducing a hydrocarbon feedstock to a reactor, wherein the reactor contains therein a catalyst, and wherein the reactor is substantially absent of oxygen and water, and wherein the catalyst includes a sand supported metal catalyst, an aluminum compound supported metal catalyst, or a combination thereof; and reacting the hydrocarbon over the catalyst to produce solid carbon and hydrogen gas.

### FIELD OF THE DISCLOSURE The present disclosure relates generally to production of hydrogen.

### BACKGROUND OF THE DISCLOSURE

Hydrogen is an emerging clean fuel source with potential to power energy storage, electrical production, vehicle propulsion, and other applications. Hydrogen can be converted to usable energy (including electrical energy) with low or no emissions using technologies such as fuel cells, as the product of hydrogen used in fuel cells is water.

Methane (CH₄) derived from natural gas is the current conventional source for hydrogen production. Conventional methods of producing hydrogen include steam methane reforming (SMR), autothermal methane reforming (ATR), and partial oxidation of methane (POM). SMR, ATR and POM have a primary disadvantage of high CO₂ emissions that negate the clean-burning advantages of using hydrogen as a fuel source. Additional disadvantages of conventional hydrogen production methods include high energy consumption, high cost, low reaction efficiency, low process stability, and low efficiency of catalyst.

Conventional production of hydrogen (including ATR, SMR, POM) may involve use of conventional catalyst technology. Catalyst efficiency is one of the key issues with efficient hydrogen production. Conventional catalysts may have limited efficiency and limited lifespan due to the compositions of the catalyst, size effects, surface area effects, porosity, defect density, promotor effects, support effects, coordination state of metal in the catalyst, acid-base properties of the catalyst, or any combination thereof.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure may include: introducing a hydrocarbon feedstock to a reactor, wherein the reactor contains therein a catalyst, and wherein the reactor is substantially absent of oxygen and water, and wherein the catalyst comprises a sand supported metal catalyst, an aluminum compound supported metal catalyst, or a combination thereof; and reacting the hydrocarbon over the catalyst to produce solid carbon and hydrogen gas.

A second nonlimiting example method of the present disclosure may include: purging the reactor with an inert gas prior to introducing a hydrocarbon so as to remove air, water, or a combination thereof, wherein the inert gas comprises nitrogen, argon, or any combination thereof introducing a hydrocarbon to a reactor, wherein the reactor contains therein a catalyst, and wherein the reactor is substantially absent of the air and the water, and wherein the catalyst comprises an aluminum compound supported metal catalyst; and reacting the hydrocarbon with the catalyst to produce solid carbon and product gas, wherein the product gas comprises hydrogen gas.

A third nonlimiting example method of the present disclosure may include: introducing a hydrocarbon to a reactor, wherein the reactor contains therein a catalyst, and wherein the reactor is substantially absent of air and water, wherein the catalyst comprises: (a) a sand supported metal catalyst, wherein the sand supported metal catalyst comprises sand and iron powder, (b) an aluminum compound supported metal catalyst, wherein the aluminum compound supported metal catalyst comprises nickel oxide and calcium aluminate, or (c) a combination of (a) and (b); and reacting the hydrocarbon with the catalyst to produce solid carbon and product gas, wherein the product gas comprises hydrogen gas.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flow chart of a nonlimiting example method for producing hydrogen from a hydrocarbon according to the present disclosure.

FIG. 2 a diagram of nonlimiting example system for production of hydrogen from a hydrocarbon according to the present disclosure.

FIG. 3 is a graph showing the methane conversion efficiency in Example 1.

FIG. 4 is a graph showing the methane conversion efficiency in Example 2.

FIG. 5 is a graph showing the methane conversion efficiency in Example 3.

FIG. 6 is a graph showing the methane conversion efficiency in Example 4.

FIG. 7 is a graph showing the methane conversion efficiency in Example 5.

FIG. 8 is an image showing a mixture of solid carbon byproducts from Example 3.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to the production of hydrogen.

The present disclosure provides methods and systems for hydrogen production from hydrocarbons (e.g., methane, crude oil, gasoline, the like) utilizing pyrolysis, wherein little or no carbon dioxide or carbon monoxide is released. Conventional production of hydrogen from hydrocarbons generally releases significant carbon dioxide and/or carbon monoxide. Methods and systems of the present disclosure limit such release through the use of a reactor environment having little or no oxygen or water therein, as, without being bound by theory, such oxygen or water would potentially react to form carbon dioxide and/or carbon monoxide. The present disclosure allows for production of hydrogen from hydrocarbons with low or no greenhouse gas emissions, thus increasing sustainability of the hydrogen produced. In order to undergo said hydrogen production, methods and systems of the present disclosure may include a reactor system with a catalyst therein, the catalyst preferably comprising a sand supported metal catalyst, an aluminum compound supported metal catalyst, or a combination thereof. “Metal catalyst,” and grammatical variants thereof as used herein refers to any catalyst comprising a metal, metal compound, or a combination thereof. “Aluminum compound,” and grammatical variants thereof as used herein refers to any compound that may have aluminum (e.g., aluminum (III) oxide, calcium aluminate, the like, or any combination thereof). The catalysts described herein may provide increased reactivity, increased durability, and increased specificity, allowing for greater efficiency in production of hydrogen. Additionally, efficiency of production herein may be enabled through use of a heating source that may allow for increased activity of the catalyst and/or may derive energy from a source with low or no greenhouse gas emissions.

“Catalyst,” “catalytic,” “catalysis,” and grammatical variants thereof, as used herein, refers to a chemical compound (or process of using such a chemical compound) that increases the rate of a chemical reaction without being consumed during the reaction. A catalyst may comprise an active catalyst and additional components such as, for example, a catalyst support, a catalyst promotor, the like, or any combination thereof.

Without being bound by theory, a catalyst of the present disclosure may react with the hydrocarbon according to a pyrolysis reaction, demonstrated in Equation 1, shown below.

CₙHₘ→nC+(m/2)H₂ Equation 1

where n is greater than or equal to 1 and m is less than or equal to 2n+2. It should be noted that the reaction in Equation 1 is preferably endothermic. As shown, the pyrolysis reaction does not include air (e.g., oxygen) or water in the reaction, and does not produce carbon dioxide or carbon monoxide.

As a nonlimiting example the catalyst may produce hydrogen from methane in absence of both air and water through a pyrolysis reaction, demonstrated in Equation 2, shown below.

CH₄→C+2H₂ Equation 2

Without being bound by theory, the enthalpy of reaction of Equation 2 is +75.6 kJ per mole, indicating it is endothermic.

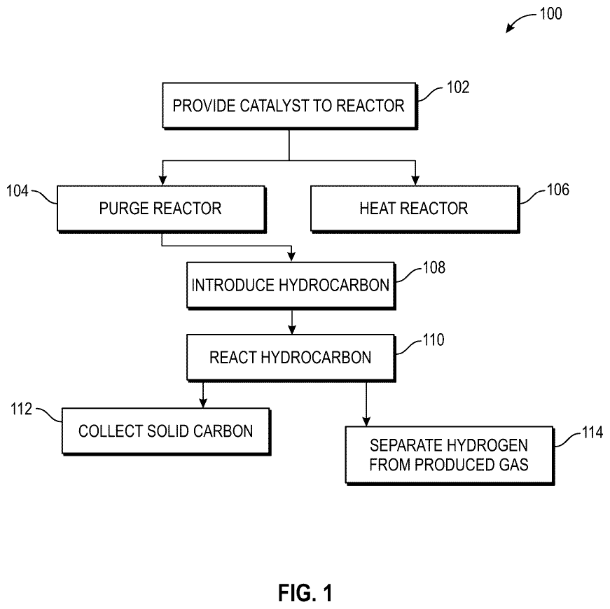

A flow chart of a nonlimiting example method for producing hydrogen from a hydrocarbon according to the present disclosure is shown in FIG. 1. Method 100 includes wherein the catalyst is provided to the reactor (block 102). Following introduction of the catalyst 102, a purge gas may be introduced to the reactor (block 104). While purge gas is being introduced 104, the reactor may begin to be heated (block 106). It should be noted that heating of the reactor 106 generally occurs during the purging step, and is generally continuous to maintain the heat of the reactor during the reaction process. Following purging 104, a hydrocarbon feedstock may be introduced to the reactor (block 108) when the reactor reaches to the desired reaction temperature. Introducing the hydrocarbon 108 allows the hydrocarbon to interact in the presence of the catalyst (block 110) and form a product including solid carbon and a produced gas comprising hydrogen. The solid carbon may be separated from the produced gas and collected (block 112), and hydrogen gas may be separated from the produced gas (block 114). Following the separation of hydrogen gas 114, the hydrogen gas may be delivered for further use and/or processing. In some cases, the solid carbon may be continuously removed during the reaction process.

Purging the reactor serves to remove any air or water from the reactor. A purge gas may be used to purge the reactor prior to introducing the hydrocarbon. Examples of a purge gas may include, but are not limited to, nitrogen, argon, the like, or any combination thereof. Purging may occur at any suitable flowrate, and may depend on factors including, but not limited to, the size of the reactor, the geometry of the reactor, the surrounding temperature, the like, or any combination thereof. Purging may occur for a purge time, the purge time being from 5 min to 5hours (or 5 min to 3 hours, or 5 min to 90 min, or 10 min to 90 min, or 15 min to 90 min, or 5 min to 60 min, or 10 min to 60 min, or 15 min to 60 min, or 5 min to 30 min, or 10 min to 30 min, or 15 min to 30 min).

The reactor may operate at any suitable temperature and pressure. Preferably the reactor may operate at a temperature from 300° C. to 1200° C. (or 300° C. to 1000° C., or 400° C. to 1000° C., or 400° C. to 900° C., or 500° C. to 900° C., or 500° C. to 800° C., or 600° C. to 800° C., or about 500° C., or about 600° C., or about 700° C., or about 800° C., or 450° C. to 550° C., or 550° C. to 650° C., or 650° C. to 750° C., or 750° C. to 850° C.). Preferably the reactor may operate at a pressure from 1 bar to 25 bar (or 1 bar to 20 bar, or 1 bar to 10 bar, or 5 bar to 15 bar, or 10 bar to 20 bar, or 15 bar to 25 bar, or 0.1 bar to 25 bar). Temperatures and pressures outside the aforementioned ranges are additionally contemplated.

The reactor may output a produced gas. It should be noted that other impurities may be formed in the reactor in addition to the produced gas and the solid carbon and may be intermixed with the produced gas, the solid carbon, or both. The solid carbon may be of any form including, but not limited to, amorphous carbon, carbon nanotubes, nanofibers, graphite, graphene, the like, or any combination thereof. Separating the hydrogen gas and the solid carbon within the produced gas may comprise passing the hydrogen gas through a separation system that may include a solid carbon collection unit, a gas separation unit, or a combination thereof. The solid carbon collection unit may comprise a cyclonic separation unit in any suitable form. The gas separation unit may comprise any suitable gas separation unit including, but not limited to, for example, a separation membrane. A separation membrane may separate the hydrogen gas and the solid carbon, from any impurities, or any combination thereof. Any suitable separation membrane may be used.

Any of the reactors described in any system above may contain a heating system to heat the reactor. The reactor may be heated at any suitable rate, including, but not limited to, for example, a heating rate of from 1° C./min to 30° C./min (or 1° C./min to 20° C./min, or 1° C./min to 15° C./min, or 1° C./min to 10° C./min, or 5° C./min to 10° C./min, or about 5° C./min, or about 10° C./min, or about 15° C./min, or about 20° C./min). The heating system of the reactor may require extensive thermal duty, and thus use of a heating method with low or no greenhouse gas emissions may be preferred, though any suitable heating method may be used. Suitable heating methods for use in the present disclosure may include, but are not limited to, hydrocarbon heating, induction heating, plasma heating (e.g., microwave plasma, the like, or any combination thereof), microwave heating, solar furnace heating, radiant heating, the like, or any combination thereof.

Hydrocarbon heating may comprise burning a hydrocarbon (e.g., natural gas, gasoline, the like, or any combination thereof) in order to provide thermal energy. It should be noted that any suitable heat conduction material (e.g., a heat transfer fluid, the like, or any combination thereof) may be used to convey heat energy from the burning of the hydrocarbon to the reactor.

The heating system may comprise induction heating. In an induction heating system an electrical current may flow through metal coils to heat metal within the catalyst through electromagnetic induction. Induction heating may increase efficiency of heating by reducing waste heat loss, thus improving the energy efficiency of the reactor.

Plasma heating may comprise a system wherein heat is provided through heating of gases within the reactor to produce plasma. Microwave heating may comprise a system wherein metal coils are used to produce microwave radiation, heating species within the reactor. Solar furnace heating may comprise a system that utilizes thermal energy from solar radiation and conveys the solar radiation thermal energy to the reactor in order to heat the reactor.

For any of the above-described heating methods that require electrical energy (e.g., microwave heating, radiant heating, induction heating, the like), said electrical energy for heating the reactor may be derived from a source with low or no greenhouse gas emissions (e.g., solar energy, wind energy, hydropower energy, nuclear energy, the like, or any combination thereof).

### Catalyst

The catalysts of the present disclosure as used in a reaction or reaction system may comprise any suitable catalyst. The catalyst may comprise an active catalyst, and may further comprise a catalyst promotor, a catalyst support, or any combination thereof.

The active catalyst may comprise any suitable compound. “Active catalyst” and grammatical variants thereof, as used herein, refer to a compound provided within a catalyst that actively provides catalyst functionality. Example suitable active catalyst compounds may include, but are not limited to, cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, beryllium, a carbide, a boride, a borocarbide, a nitride, a silicide, an aluminide, an oxide (e.g., aluminum (III) oxide (Al₂O₃)), a phosphide, a phosphate, a sulfide, a sulfate, a hydride, a hydrate, a carbonitride, graphene, graphene oxide, carbon nanotubes, graphite, the like, or any combination thereof.

The active catalyst may have a concentration in the catalyst of from 5 atomic percent (at %) to 95 at % (or 10 at % to 95 at %, or 10 at % to 90 at %, or 15 at % to 95 at %, or 20 at % to 90 at %, or 20 at % to 70 at %, or 40 at % to 90 at %).

A catalyst promotor may be included in the catalyst. “Catalyst promotor” and grammatical variants thereof, as used herein, refer to a compound provided within a catalyst for increasing the catalytic activity of the catalyst. The catalyst promotor used in the present disclosure may comprise any suitable catalyst promotor material. Suitable catalyst promotor materials may include, but are not limited to, an alkali metal (e.g., lithium, sodium, potassium, cesium, francium, or any combination thereof), an alkali earth metal (e.g., calcium, magnesium, barium, or any combination thereof) a transition metal (e.g., iron, cobalt, manganese, nickel, molybdenum, copper, palladium, platinum, rhenium, chromium, zinc, zirconium, ruthenium, rhodium, silver, tungsten, iridium, gold, or any combination thereof), a post-transition metal (e.g., aluminum, tin, or any combination thereof), a cerium compound (e.g., cerium, a cerium oxide (e.g., Ce₂O₃, CeO₂, or any combination thereof), or any combination thereof), a lanthanide (e.g., lanthanum, neodymium, ytterbium, or any combination thereof), a metal oxide (e.g., MgO, Ca₂SiO₄, CaO, or any combination thereof), the like, or any combination thereof. Other examples of suitable catalyst promotors may include, but are not limited to, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof.

The catalyst promotor may have a concentration in the catalyst of from 0.0001 at % to 30 at % (or 0.0001 at % to 25 at %, or 0.0001 at % to 20 at %, or 0.0001 at % to 15 at %, or 0.5 at % to 30 at %, or 0.5 at % to 25 at %, or 0.5 at % to 20 at %, or 0.5 at % to 15 at %).

The catalyst promotor used in the present disclosure may serve as a chemical promotor, a structural promotor, or any combination thereof. When serving as a chemical promotor, the catalyst promotor may improve the efficiency of the catalyst by, without being bound by theory, altering the distribution of electrons at the surface of the catalyst. When serving as a structural promotor, the catalyst promotor may alter mechanical properties of the catalyst such as, for example, increase sintering resistance. The catalyst promotor may also provide additional features such as increasing selectivity of the catalyst for a particular reactant. Without being bound by theory, the catalyst promotor may increase adsorption and chemisorption for a specific reactant at an active site of the catalyst, thus increasing selectivity. The catalyst promotor may also increase the durability of the catalyst.

A catalyst support may be included in the catalyst. “Catalyst support” and grammatical variants thereof, as used herein, refers to a compound or material to which the catalyst is affixed for providing additional features. The catalyst support used in the present disclosure may comprise any suitable catalyst support material including, but not limited to, a metal, a metal oxide, the like, or any combination thereof. Suitable metal oxides may include, but are not limited to, CaAl₂O₄, CaAl₄O₇, CaAl₁₂O₁₉, Al₂O₃, Al₂O₄, SiO₂, MgO, TiO₂, Fe₂O₃, FeO, ZrO₂, CeO₂, a lanthanide oxide (e.g., Er₂O₃), the like, or any combination thereof. Other examples of suitable catalyst supports may include, but are not limited to, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof. The catalyst support may preferably comprise sand, including the components therein.

The catalyst support may have a concentration in the catalyst of from 0.0001 at % to 60 at % (or 0.0001 at % to 50 at %, or 0.0001 at % to 40 at %, or 0.0001 at % to 20 at %, or 0.5 at % to 60 at %, or 0.5 at % to 50 at %, or 0.5 at % to 40 at %, or 0.5 at % to 20 at %).

The catalyst support, when added to the catalyst may serve to increase the efficiency of the catalysis. The catalyst support may provide features to the catalyst such as, for example, increasing alloy dispersion, improving sintering resistance, increasing the rate of reactant adsorption, or any combination thereof. The catalyst support may additionally prevent carbon formation on the surface of the catalyst, maintaining increased catalyst activity for a longer time duration. The catalyst support may function by interacting chemically, physically, or chemically and physically, with the other components of the catalyst, a reaction substrate, or any combination thereof.

It should be noted that in some embodiments the catalyst promotor may be a compound that in other embodiments may be a catalyst support, and yet in other embodiments may comprise the active catalyst. In other words, a single compound may provide catalytic activity in some embodiments, may serve as a catalyst promotor in other embodiments, and may serve as a catalyst support in yet other embodiments. Without being bound by theory, the function of a compound may be determined by other components in the catalyst and interactions with the other elements and compounds. By way of an illustrative nonlimiting example, in a first case a catalyst may comprise an active catalyst wherein the active catalyst comprises nickel and copper, and wherein the catalyst further comprises graphene as a catalyst promotor. Continuing the nonlimiting example, in a second case a catalyst may comprise an active catalyst wherein the active catalyst comprises nickel and graphene, and wherein the catalyst further comprises copper as a catalyst promotor. Continuing the nonlimiting example, in a third case a catalyst may comprise an active catalyst wherein the active catalyst comprises nickel and graphene, and wherein the catalyst further comprises copper as a catalyst support. In the aforementioned nonlimiting examples, copper may, depending on the embodiment, function as the active catalyst, may serve as a catalyst promotor, or may serve as a catalyst support.

Additionally, the catalyst may preferably comprise sand (e.g., beach sand, desert sand, Saudi sand, the like, or any combination thereof), and more preferably may comprise a sand supported metal catalyst. Sand may, as a nonlimiting example, comprise compounds including, by weight of the sand, from 0.1 wt % 1 wt % Sodium (Na), from 0.1 wt % 0.5 wt % Magnesium (Mg), from 1 wt % to 5 wt % Aluminum (Al) and/or Aluminum (III) Oxide (Al₂O₃), from 0.1 wt % to 1 wt % Potassium (K), from 0.1 wt % to 2 wt % Calcium (Ca), from 0.1 wt % to 0.5 wt % Titanium (Ti), from 0.1 wt % to 5 wt % Iron (Fe), and from 50 wt % to 90% wt % Silicon Dioxide (SiO₂). The catalyst may preferably comprise a combination of sand and iron (e.g., iron powder) in any suitable proportions. The catalyst may preferably comprise, by weight of the catalyst, from 5 wt % to 100wt % (or 5 wt % to 95 wt %, or 8 wt % to 100 wt %, or 8 wt % to 95 wt %, or 10 wt % to 90 wt %, or 30 wt % to 80 wt %, or about 10 wt %, or about 50 wt %, or about 100 wt %) sand, and from 0 wt % to 95 wt % (or 0 wt % to 90 wt %, or 10 wt % to 90 wt %, or about 0 wt %, or about 95 wt %, or about 90 wt %) iron (e.g., iron powder).

It should be noted that various compounds within the sand may each serve as an active catalyst, a catalyst support, or a catalyst promotor, including wherein a single compound within the sand may provide active catalyst function in some embodiments, may serve as a catalyst promotor in other embodiments, and may serve as a catalyst support in yet other embodiments. As a nonlimiting example in a first embodiment, a catalyst may comprise sand, wherein the active catalyst comprises aluminum (III) oxide and magnesium, and wherein the catalyst further comprises silicon dioxide as a catalyst support. Continuing the nonlimiting example, in a second case a catalyst may comprise sand, wherein the active catalyst comprises aluminum (III) oxide, wherein the catalyst further comprises magnesium as a catalyst promotor, and wherein the catalyst further comprises silicon dioxide as a catalyst support.

The catalyst may preferably comprise an aluminum compound supported metal catalyst. Example aluminum supported metal catalysts may include, for example, but are not limited to, a nickel oxide (NiO) and calcium aluminate (CaAl) catalyst. A commercial example of a catalyst comprising NiO and CaAl may include, but is not limited to, REFORMAX® 330 LDP Plus (available from Clariant specialty chemicals). REFORMAX® 330 LDP Plus is a Ni-compound catalyst (including NiO and CaAl) and may have an included catalyst support. Without being bound by theory, REFORMAX® 330 LDP Plus and/or like catalysts may provide increased catalyst efficiency and function due to factors including, but not limited to, the nickel content and distribution with the catalyst and catalyst support, pore size distribution, surface area, physical integrity, the like, or any combination thereof.

The catalyst may be present in the form of a plurality of particles. The plurality of particles may have an average dimension from 1 nanometer (nm) to 999 micrometers (μm) (or 1 nm to 500 μm, or 1 nm to 10 μm, or 1 nm to 999 nm, or 1 μm to 999 μm, or 1 μm to 100 μm, or about 50 μm). Dimensions outside the aforementioned ranges are additionally contemplated. The average dimension of the plurality of particles may be defined as the average width, length, height, diameter, or any combination thereof of a particle. The particles may be of any shape including, but not limited to, spherical, cubic, triangular, oblong, irregular, or any combination thereof. The plurality of particles may be formed to a catalyst bead, catalyst pellet, or any combination thereof in any suitable shape and size.

It should be noted that the catalyst may be further processed in order to modify features of the catalyst including, but not limited to, the size, shape, the like, or any combination thereof. Example further processes for the catalyst will be known to one of ordinary skill in the art. As an example, the catalyst may be ball-milled, including ball-milled using zirconia media (e.g., yttria stabilized zirconia). Ball-milling of the catalyst may occur at any suitable revolution frequency and for any suitable length of time. Ball-milling of the catalyst may preferably occur at a revolution frequency of from 100 revolutions per minute (rpm) to 2000 rpm (or 100 rpm to 1500 rpm, or 100 rpm to 1200 rpm, or 1000 rpm to 1200 rpm, or about 1100 rpm). Ball-milling of the catalyst may preferably occur for a duration of from 1 day to 20 days (or 1 day to 8 days, or 1 day to 5 days, or 1 day to 4 days, or 1 day to 2 days, or about 1 day).

During reaction, catalyst may be housed in the reactor in any suitable fashion including, but not limited to, a catalyst bed (e.g., a fluidized bed), the like, or any combination thereof.

### Hydrocarbon

The hydrocarbon used for manufacturing of hydrogen may comprise any suitable hydrocarbon, for example, including, but not limited to, methane, propane, gasoline, kerosene, diesel fuel, residual oil, crude oil, the like, or any combination thereof.

The hydrocarbon may enter the reactor at any suitable pressure, temperature, and flowrate compatible with the reaction conditions of the reactor. If the hydrocarbon is introduced in gaseous form, the hydrocarbon may further comprise an inert carrier gas (e.g., nitrogen gas, argon, the like, or any combination thereof). While in the reactor, the hydrocarbon may be catalyzed by the catalyst to form the produced gas comprising hydrogen and the solid carbon.

### Hydrogen Gas

The hydrogen gas produced may be of any suitable purity including from 90 mol % to 99.99 mol % percent purity (or 60 mol % to 99.99 mol %, or 80 mol % to 99.99 mol %, or 95 mol % to 99.99 mol %, or greater than 99.99 mol %). The hydrogen gas produced may be provided at any suitable temperature and pressure. The pressure and temperature of the hydrogen gas produced may be affected by the pressure and temperature of the reactor or any other unit described herein. The hydrogen gas produced may subsequently be directed to any suitable location including, but not limited to, a pipeline, a storage tank, a railcar tank, the like, or any combination thereof.

### Systems

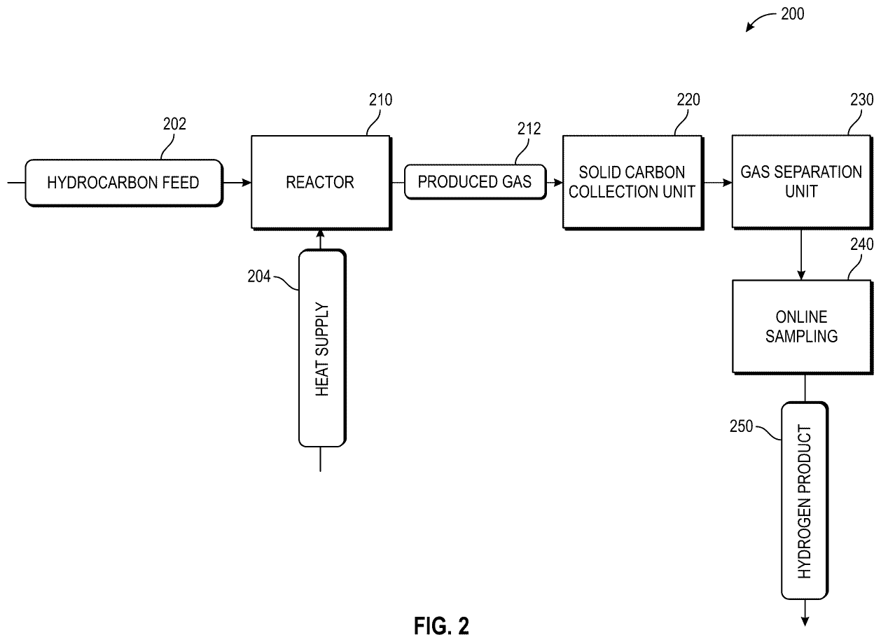

A diagram of nonlimiting example system of the present disclosure for production of hydrogen is shown in FIG. 2. System 200 includes a reactor 210 with a hydrocarbon feed 202 and heat supply 204 to the reactor 210. The reactor 210 may comprise catalyst therein, as discussed above. Following processing through the reactor 210 a produced gas stream 212 may enter one or more units for further processing, including a solid carbon collection unit 220 and gas separation unit 230. The system may, optionally, include online sampling equipment 240. Upon passing through the solid carbon collection unit 220, the gas separation unit 230, and the optional online sampling equipment 240, a hydrogen product stream 250 comprising hydrogen gas produced may be furnished. The hydrogen product stream 250 may be directed anywhere suitably as described above.

The overall system may have any suitable conversion efficiency, including, but not limited to, a conversion efficiency of from 20% to 99.9% (or 20% to 60%, or 60% to 99.9%, or greater than 99.9%). “Conversion efficiency,” as used herein, refers to a ratio of the actual conversion of a reactant to the theoretical stoichiometric conversion, and may be expressed as a percentage (%). Using methane (CH₄) as a nonlimiting example, if a 100% conversion efficiency is achieved, one mole of CH₄ can generate 2 moles of hydrogen H₂. Continuing the nonlimiting example, the methane conversion efficiency, MCE, may be calculated by Equation 3 below.

MCE=(R_{HYDROGEN}/2)/(R_{HYDROGEN}/2+R_{UNREACTED METHANE})*100 Equation 3

where R_{HYDROGEN} is the quantity of hydrogen generated in the outlet, and R_{UNREACTED METHANE} is the quantity of unreacted methane in the outlet. The system may include any suitable recycling streams and devices, which are not depicted herein, for further increasing the efficiency of conversion.

It additionally should be noted that methods and systems of the present disclosure may include operation of reactors described herein in any suitable manner, including any suitable configuration (e.g., in parallel, in series, the like, or a combination thereof) and including any suitable operational fashion (e.g., a continuous fashion, a batch-wise fashion, the like, or a combination thereof).

It should be appreciated that one skilled in the art should be able to, with the benefit of this disclosure, implement the methods and systems described above. It should be noted that additional nonlimiting components may be utilized in the methods and systems described above to produce hydrogen. Such additional components will be familiar to one having ordinary skill in the art and may include, but are not limited to, valves, pumps, joints, sensors, compressors, controllers, heat exchangers, sampling equipment (e.g., gas chromatography), the like, or any combination thereof.

### EXAMPLES

### Example 1

About 10 g of REFORMAX® 330 LDP Plus catalyst was loaded into a vertical tubular reactor equipped with a quartz tube with 1 inch diameter and 530 mm length (22 mm ID×25 mm OD×530 mm length with #4 porosity Frit 200 mm from bottom). Subsequently, the quartz tube was closed on both ends by closures with suitable gas inlets and gas outlets. The system was purged with nitrogen gas to remove oxygen in the reactor environment. Subsequently, reactor heating was initiated to a reaction temperature of 500° C. with 10° C. per minute as the heating rate while maintaining nitrogen gas flow. When the reactor reached the desired reaction temperature, the gas flow was switched to methane with 100 mL/min as the flow rate.

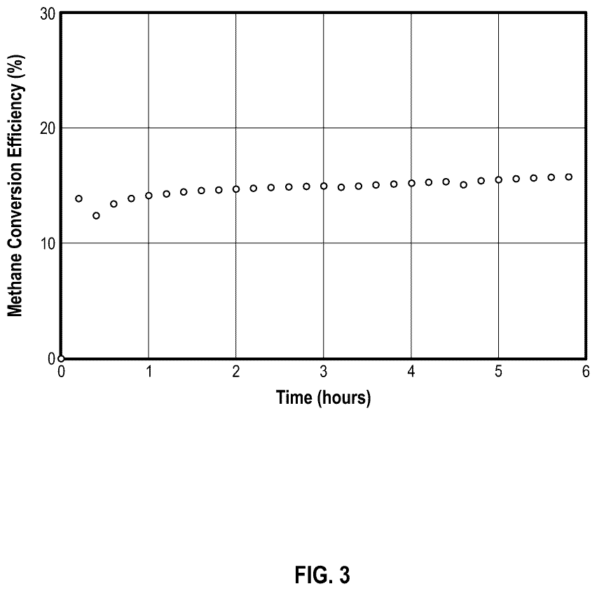

The exhaust gas comprising produced hydrogen, unreacted methane, and other possible produced gases was analyzed by online gas-chromatography. The methane conversion efficiency percentage (%) is shown in a graph in FIG. 3. As shown in FIG. 3, the methane conversion efficiency % is about 15%.

### Example 2

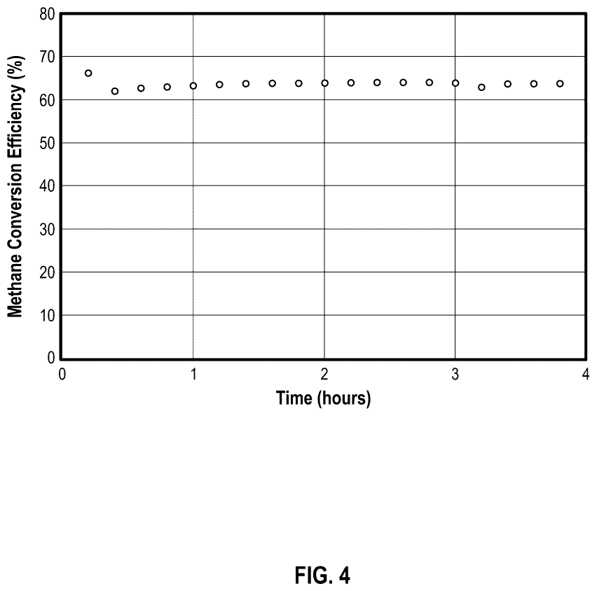

Example 1 was repeated, except the reaction temperature was about 600° C. The exhaust gas comprising produced hydrogen, unreacted methane, and other possible produced gases was analyzed by online gas-chromatography. The methane conversion efficiency % is shown in a graph in FIG. 4. As shown in FIG. 4, the methane conversion efficiency % leveled off at about 63%.

### Example 3

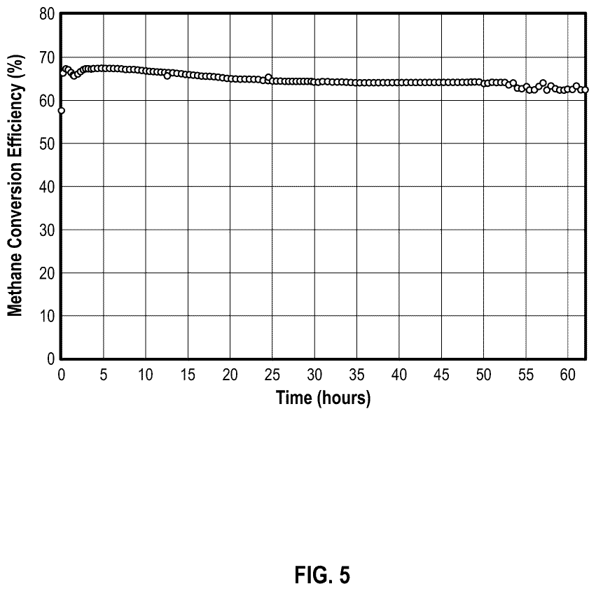

Example 1 was repeated, except the reaction temperature was about 700° C. The exhaust gas comprising produced hydrogen, unreacted methane, and other possible produced gases was analyzed by online gas-chromatography. The methane conversion efficiency % is shown in a graph in FIG. 5. As shown in FIG. 5, the methane conversion efficiency % leveled off at about 65% to about 70%. The catalyst was additionally shown to be stable for at least 60 hours at 700° C.

Example 4

100 mesh sand was obtained. The 100 mesh sand included, by weight of the sand, 0.1 wt % to 1 wt % Sodium (Na), 0.1 wt % to 0.5 wt % Magnesium (Mg), 1 wt % to 5 wt % Aluminum (Al) and/or Aluminum (III) Oxide (Al₂O₃), 0.1 wt % to 1 wt % Potassium (K), 0.1 wt % to 2 wt % Calcium (Ca), 0.1 wt % to 0.5 wt % Titanium (Ti), 0.1 wt % to 5 wt % Iron (Fe), and 50 wt % to 90% wt % Silicon Dioxide (SiO₂). The sand comprised additional traces of rare elements.

350 g of 5 mm zirconia media (e.g., yttria stabilized zirconia) were used to ball-mill 80 g of 100 mesh sand at room temperature (about 25° C.) for 4 days at 1100 rpm. The ball-milled sand was separated using a 30 mesh sieve and samples were collected. The average particle size of the ball-milled sand was about 50 μm.

About 20 g of ball-milled sand was loaded into a vertical tubular reactor equipped with a quartz tube with 1 inch diameter and 530 mm length (22 mm ID×25 mm OD×530 mm length with #4 porosity Frit 200 mm from bottom). The quartz tube was closed on both ends by closures with suitable gas inlets and gas outlets. The system was purged with nitrogen gas to remove oxygen in the reactor environment. Subsequently, reactor heating was initiated to a reaction temperature of 700° C. with 10° C. per minute as the heating rate while maintaining nitrogen gas flow. When the reactor reached the desired reaction temperature, the gas flow was switched to methane with a flow rate 20 mL/min.

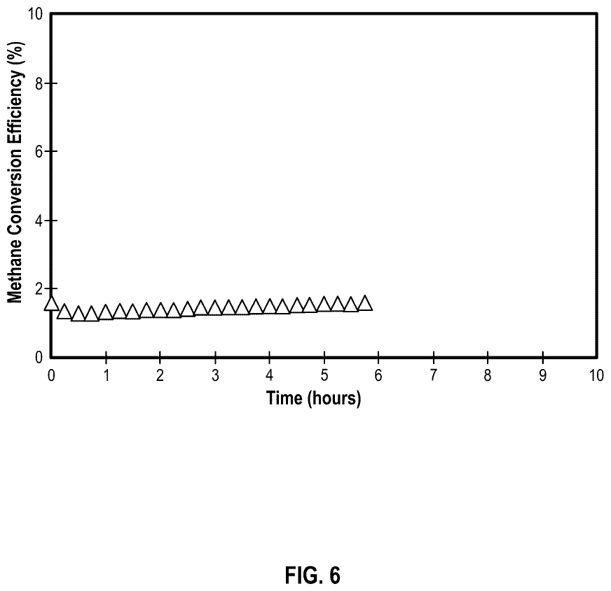

The exhaust gas comprising produced hydrogen, unreacted methane, and other possible produced gases was analyzed by online gas-chromatography. The methane conversion efficiency % is shown in a graph in FIG. 6. As shown in FIG. 6, the methane conversion efficiency % is between about 1% to about 2%.

### Example 5

9 g of the ball-milled sand of Example 4 was mixed with 90 g Fe powder (Matexcel), 0.25 g of CaCl₂, and 0.75 g of Ni powder, and further ball-milled using 150 g of 3 mm zirconia media (e.g., yttria stabilized zirconia) and 200 g of 1 mm zirconia media at room temperature (about 25° C.) for 4 days at 1100 rpm, then the Fe-containing ball-milled composite was separated using a sieve and samples were collected.

About 20 g of the Fe-containing ball-milled composite was loaded into a vertical tubular reactor and reacted according to the process of Example 4.

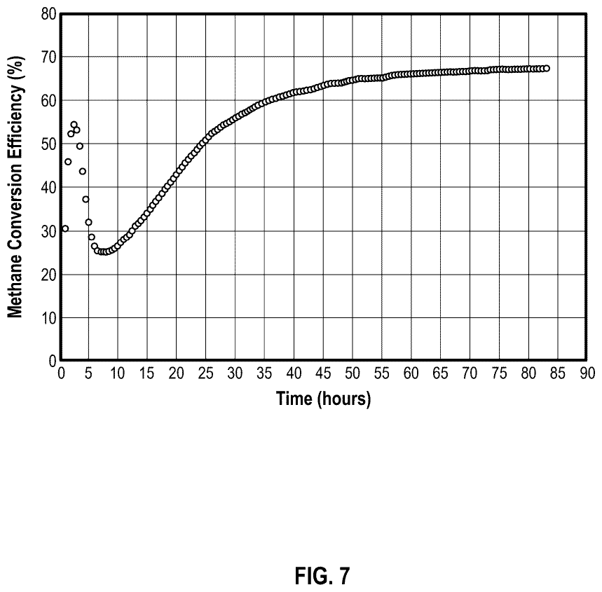

The exhaust gas comprising produced hydrogen, unreacted methane, and other possible produced gases were analyzed by online gas-chromatography. The methane conversion efficiency % is shown in a graph in FIG. 7. As shown in FIG. 7, the methane conversion efficiency % leveled off at about 67%. The catalyst was additionally shown to be stable for at least 88 hours at 700° C.

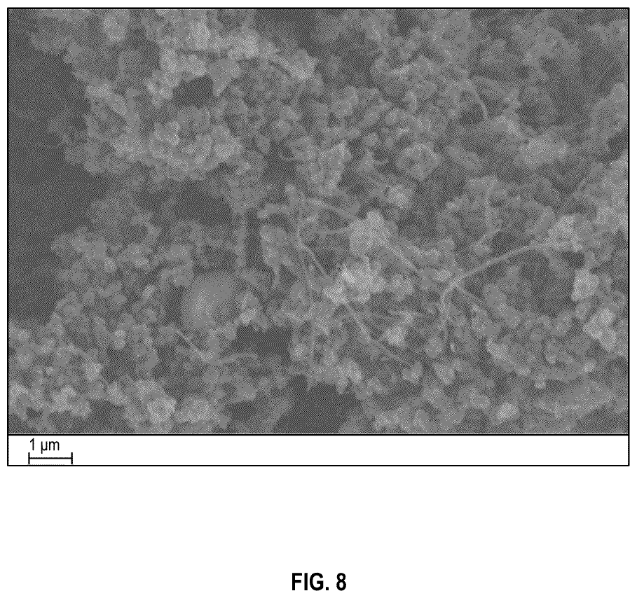

Additionally, solid carbon byproducts were collected after the reaction. An image showing a mixture of solid carbon byproducts from Example 3 can be seen in FIG. 8. As shown, the solid carbon byproduct includes a mixture of black carbon, nanotubes, and nanofibers.

### Additional Embodiments

Embodiment 1. A method comprising: introducing a hydrocarbon feedstock to a reactor, wherein the reactor contains therein a catalyst, and wherein the reactor is substantially absent of oxygen and water, and wherein the catalyst comprises a sand supported metal catalyst, an aluminum compound supported metal catalyst, or a combination thereof; and reacting the hydrocarbon over the catalyst to produce solid carbon and hydrogen gas.

Embodiment 2. The method of Embodiment 1, wherein the catalyst is located in a fluidized bed within the reactor.

Embodiment 3. The method of Embodiment 1 or 2, further comprising purging the reactor with an inert gas prior to introducing the hydrocarbon to remove the air, the water, or a combination thereof.

Embodiment 4. The method of Embodiment 3, wherein the inert gas comprises nitrogen, argon, or any combination thereof.

Embodiment 5. The method of Embodiments 3 or 4, further comprising heating the reactor at least partially during purging of the reactor.

Embodiment 6. The method of Embodiment 5, wherein the reactor is heated by hydrocarbon heating, induction heating, plasma heating, microwave heating, solar furnace heating, radiative heating, or any combination thereof.

Embodiment 7. The method of Embodiment 6, wherein electrical energy for heating the reactor is sourced from a renewable generation source.

Embodiment 8. The method of any one of Embodiments 1-7, further comprising collecting the solid carbon.

Embodiment 9. The method of Embodiment 8, wherein the collecting uses a cyclonic separator.

Embodiment 10. The method of any one of Embodiments 1-9, further comprising separating the hydrogen gas from the solid carbon and remaining hydrocarbon.

Embodiment 11. The method of Embodiment 10, wherein the separating uses a separation membrane.

Embodiment 12. The method of any one of Embodiments 1-11, wherein the hydrocarbon comprises methane, propane, gasoline, kerosene, diesel fuel, residual oil, crude oil, or any combination thereof.

Embodiment 13. The method of any one of Embodiments 1-12, wherein the aluminum supported metal catalyst comprises nickel oxide and calcium aluminate.

Embodiment 14. The method of any one of Embodiments 1-13, wherein the sand supported metal catalyst comprises sand and iron.

Embodiment 15. The method of any one of Embodiments 1-14, wherein the catalyst further comprises a catalyst support and the catalyst support comprises: a metal, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof.

Embodiment 16. The method of any one of Embodiments 1-15, wherein the catalyst further comprises a catalyst promotor and wherein the catalyst promotor comprises: an alkali metal, an alkali earth metal, a transition metal, a post-transition metal, a cerium compound, a lanthanide, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof.

Embodiment 17. The method of any one of Embodiments 1-16, wherein a temperature of the reactor is from 300° C. to 1200° C.

Embodiment 18. A method comprising: purging the reactor with an inert gas prior to introducing a hydrocarbon so as to remove air, water, or a combination thereof, wherein the inert gas comprises nitrogen, argon, or any combination thereof introducing a hydrocarbon to a reactor, wherein the reactor contains therein a catalyst, and wherein the reactor is substantially absent of the air and the water, and wherein the catalyst comprises an aluminum compound supported metal catalyst; and reacting the hydrocarbon with the catalyst to produce solid carbon and product gas, wherein the product gas comprises hydrogen gas.

Embodiment 19. The method of Embodiment 18, wherein the hydrocarbon comprises methane, propane, gasoline, kerosene, diesel fuel, residual oil, crude oil, or any combination thereof.

Embodiment 20. A method comprising: introducing a hydrocarbon to a reactor, wherein the reactor contains therein a catalyst, and wherein the reactor is substantially absent of air and water, wherein the catalyst comprises: (a) a sand supported metal catalyst, wherein the sand supported metal catalyst comprises sand and iron powder, (b) an aluminum compound supported metal catalyst, wherein the aluminum compound supported metal catalyst comprises nickel oxide and calcium aluminate, or (c) a combination of (a) and (b); and reacting the hydrocarbon with the catalyst to produce solid carbon and product gas, wherein the product gas comprises hydrogen gas.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
introducing a hydrocarbon feedstock to a reactor,
wherein the reactor contains therein a catalyst, and
wherein the reactor is substantially absent of oxygen and water, and
wherein the catalyst comprises a sand supported metal catalyst, an aluminum compound supported metal catalyst, or a combination thereof; and
reacting the hydrocarbon over the catalyst to produce solid carbon and hydrogen gas.

2. The method of claim 1, wherein the catalyst is located in a fluidized bed within the reactor.

3. The method of claim 1, further comprising purging the reactor with an inert gas prior to introducing the hydrocarbon to remove the air, the water, or a combination thereof.

4. The method of claim 3, wherein the inert gas comprises nitrogen, argon, or any combination thereof.

5. The method of claim 3, further comprising heating the reactor at least partially during purging of the reactor.

6. The method of claim 5, wherein the reactor is heated by hydrocarbon heating, induction heating, plasma heating, microwave heating, solar furnace heating, radiative heating, or any combination thereof.

7. The method of claim 6, wherein electrical energy for heating the reactor is sourced from a renewable generation source.

8. The method of claim 1, further comprising collecting the solid carbon.

9. The method of claim 8, wherein the collecting uses a cyclonic separator.

10. The method of claim 1, further comprising separating the hydrogen gas from the solid carbon and remaining hydrocarbon.

11. The method of claim 10, wherein the separating uses a separation membrane.

12. The method of claim 1, wherein the hydrocarbon comprises methane, propane, gasoline, kerosene, diesel fuel, residual oil, crude oil, or any combination thereof.

13. The method of claim 1, wherein the aluminum supported metal catalyst comprises nickel oxide and calcium aluminate.

14. The method of claim 1, wherein the sand supported metal catalyst comprises sand and iron.

15. The method of claim 1, wherein the catalyst further comprises a catalyst support and the catalyst support comprises: a metal, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof.

16. The method of claim 1, wherein the catalyst further comprises a catalyst promotor and wherein the catalyst promotor comprises: an alkali metal, an alkali earth metal, a transition metal, a post-transition metal, a cerium compound, a lanthanide, a carbide, a boride, a borocarbide, a nitride, a silicide, an aluminide, an oxide, a phosphide, a phosphate, a sulfide, a sulfate, a hydride, a hydrate, a carbonitride, graphene, graphene oxide, carbon nanotubes, graphite, the like, or any combination thereof.

17. The method of claim 1, wherein a temperature of the reactor is from 300° C. to 1200° C.

18. A method comprising:
purging the reactor with an inert gas prior to introducing a hydrocarbon so as to remove air, water, or a combination thereof, wherein the inert gas comprises nitrogen, argon, or any combination thereof,
introducing a hydrocarbon to a reactor, wherein the reactor contains therein a catalyst, and wherein the reactor is substantially absent of air and water, and wherein the catalyst comprises an aluminum compound supported metal catalyst; and
reacting the hydrocarbon with the catalyst to produce solid carbon and product gas, wherein the product gas comprises hydrogen gas.

19. The method of claim 18, wherein the hydrocarbon comprises methane, propane, gasoline, kerosene, diesel fuel, residual oil, crude oil, or any combination thereof.

20. A method comprising:
introducing a hydrocarbon to a reactor, wherein the reactor contains therein a catalyst, and wherein the reactor is substantially absent of air and water, wherein the catalyst comprises:
(a) a sand supported metal catalyst, wherein the sand supported metal catalyst comprises sand and iron powder,
(b) an aluminum compound supported metal catalyst, wherein the aluminum compound supported metal catalyst comprises nickel oxide and calcium aluminate, or
(c) a combination of (a) and (b); and
reacting the hydrocarbon with the catalyst to produce solid carbon and product gas, wherein the product gas comprises hydrogen gas.
